(19) United States
(12) Patent Application Publication
(10) Pub. No.: US 2017/0236214 A1
(43) Pub. Date: Aug. 17, 2017

(54) SYSTEM AND METHODS FOR IMPLEMENTING A TRANSITION TO MULTI-BOOK ACCOUNTING IN A REAL-TIME FINANCIAL MANAGEMENT SYSTEM

(71) Applicant: NETSUITE INC., SAN MATEO, CA (US)

(72) Inventors: HUI WANG, FOSTER CITY, CA (US); MICHAEL (XIAOZHENG) YE, FOSTER CITY, CA (US); STEPHEN CLODE, SAN JOSE, CA (US); BRIAN ALEXANDER PURVILLE, SAN FRANCISCO, CA (US)

(21) Appl. No.: 14/991,053

(22) Filed: Jan. 8, 2016

Related U.S. Application Data
(60) Provisional application No. 62/101,886, filed on Jan. 9, 2015.

(51) Int. Cl. G06Q 40/00

(52) U.S. Cl. CPC G06Q 40/12

(57) ABSTRACT

Systems and methods for transitioning to a multi-book accounting system involving first and second accounting books, processing real-time transactions received through a network by applying a first set of accounting rules corresponding to the first accounting book to the real-time transactions to produce the first accounting book, and applying a second set of accounting rules corresponding to the second accounting book to the real-time transaction to produce the second accounting book, where the second set of accounting rules differs from the first set of accounting rules. The first and second rules may correspond to first and second sets of attributes such that every transaction includes necessary attributes for causing data to be stored in attribute appropriate books.

### PRIORITY CLAIM

This application claims the benefit of U.S. Provisional Application No. 62/101,886, entitled “System and Methods for Implementing a Transition to Multi-Book Accounting in a Real-Time Financial Management System,” filed Jan. 9, 2015, which is incorporated by reference in its entirety herein for all purposes.

### BACKGROUND

Users of financial accounting software often need to generate multiple copies of accounting results based on the same set of business transactions, in order to comply with country and/or industry specific accounting regulations. These copies of accounting data are typically termed “Accounting Books”, with each “book” indicating one integral set of accounting results. However, these accounting books may not represent real-time or current and up-to-date financial results for an enterprise if they are copied or derived from a previously generated (and hence fixed in time) set of data.

This lack of real-time data in an accounting book can be a problem for some users of the accounting books. For example, financial controllers or certain business users may need (or require) real-time insight into the financial performance of an enterprise and prefer to rely on real-time financial data and the ability to access and manipulate information contained in the accounting books (e.g., be able to apply analytical models or decision processes to the data and utilize real-time data in those processes).

Conventional approaches used by financial accounting systems to provide controllers with access to accounting books typically involve a two-step general ledger (GL) posting logic (referred to as sub-ledger accounting), in which the business transactions are disconnected from the run-time financial impact. However, this two-step logic introduces a time lag in the financial data; as a result, users don't always have real-time access to specific accounting results and the accuracy (and hence reliability) of the data being used may be questioned.

One approach to providing a better connection between business transactions and their financial impact is the use of the elements of a multi-book accounting system, such as that described in the Appendix to this application. However, there remains the problem of how to enable a business to efficiently transition to such an accounting system and method from a conventional system. More specifically, an existing accounting system will maintain records of historical data and transactions. Whether transitioning to a multi-book system from a conventional system or creating a new book within an existing multi-book system, the historical data and transactions need to be considered and the transition to a new system or new book needs to be handled in an efficient manner that does not interfere with the accounting systems or processes.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments covered by this patent are defined by the claims and not by this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the subject matter disclosed herein are directed to systems, apparatuses, and methods for enabling a business to transition from a conventional accounting system with historical data to an automated business data processing platform or system that is configured to utilize a multi-book accounting system (i.e., one operable to generate multiple copies of real-time financial results based on pre-defined business and/or accounting rules). In one embodiment, a system and method generates multiple copies of real-time “book specific” accounting results, thereby achieving the end result of a conventional sub-ledger accounting system but with the benefit of enabling multiple copies of accounting results containing real-time financial data analytics. The book-specific accounting results may typically include both book-generic level data that may be common to all accounting books in the multi-book accounting system as well as book-specific level data that is unique to one or more (less than all) books in the multi-book accounting system. Additional embodiments are also directed to systems, apparatuses, and methods for enabling a business that is operating a multi-book accounting system to efficiently create a new book within the system while addressing the issue of historical data. Further yet, the display and manipulation of the various books in the multi-book accounting system may have differing rules based upon a role of the user of the multi-book accounting system.

Other objects and advantages will be apparent to one of ordinary skill in the art upon review of the detailed description and the included figures.

### BRIEF DESCRIPTION OF THE DRAWINGS

Embodiments of the subject matter in accordance with the present disclosure will be described with reference to the drawings, in which:

FIG. 1 is a diagram illustrating elements or components of an example operating environment in which an embodiment of the subject matter disclosed herein may be implemented;

FIG. 2 is a diagram illustrating additional details of the elements or components of the multi-tenant distributed computing service platform of FIG. 1, in which an embodiment of the subject matter disclosed herein may be implemented;

FIG. 3 is a diagram illustrating a simplified system of FIG. 1, including an integrated business system and an enterprise network in which an embodiment of the subject matter disclosed herein may be implemented;

FIG. 4 is a diagram illustrating a data schema that may be utilized in implementing an embodiment of the subject matter disclosed herein;

FIG. 5(a) is a state diagram or flow diagram illustrating an exemplary method, process, function, or operation that may be used in an implementation of an embodiment of the subject matter disclosed herein;

FIG. 5(b) is a diagram illustrating a set of steps or stages that represent an exemplary implementation of the method, process, function, or operation in the context of a multi-book accounting system;

FIG. 6 is a diagram illustrating a timeline of examples transactions before the implementation of multi-book accounting and after the implementation of multi-book accounting according to an embodiment of the subject matter disclosed herein; and

FIG. 7 is a diagram illustrating elements or components that may be present in a computer device or system configured to implement a method, process, function, or operation in accordance with an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present subject matter may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, or other form of computing or data processing device/platform and that is programmed with a set of executable instructions (e.g., software instructions), where the instructions may be stored in a suitable non-transitory data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

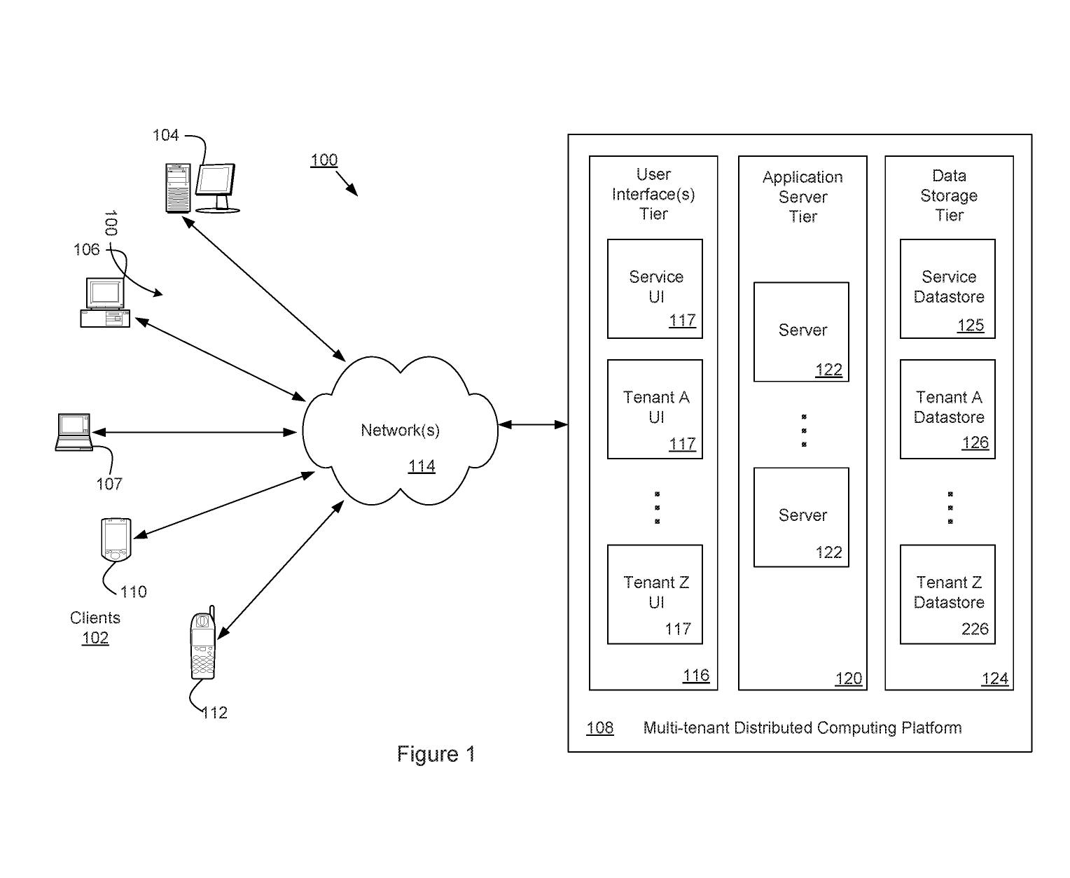

In some embodiments, the subject matter may be implemented in the context of a multi-tenant, “cloud” based environment (such as a multi-tenant business data processing platform), typically used to develop and provide web services and business applications for end users. This exemplary implementation environment will be described with reference to FIGS. 1-7 below. Note that embodiments may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. With differing levels of overlap with ERP/CRM initiatives and with each other, efforts have also been directed toward development of increasingly integrated partner and vendor management systems, as well as web store/eCommerce, product lifecycle management (PLM), and supply chain management (SCM) functionality.

Financial accounting software often is required to generate multiple copies of accounting results with the same set of business transactions in order to comply with country and industry specific accounting regulations. These copies of accounting data are technically named “Accounting Books”, with each book indicating one integral set of accounting result. Meanwhile, financial controllers and business users often want a real-time insight to their financial performance with instant data analytical access to these accounting books.

Current financial accounting systems handle this problem by using a two-step general ledger posting logic (also known as sub-ledger accounting), where the business transactions are disconnected from run-time financial impact. However, this two-step logic introduces a time lag to financial data, so users don't always have real-time access to book specific accounting results. That is, when data may first be entered into the set of accounting books, only the general ledger contains the most up-to-date data while the other sub-ledger books will lag by at least the amount of time it may take an accountant to also enter various transactions into sub-ledgers. This is specifically because the data that is entered into the sub-ledger books is some form of manipulated data from the original GL transaction. For example, a general ledger entry for a sale may include a figure that indicates total revenue generated for a transaction that is needed for the general ledger accounting, however a sub-ledger may need to break out the total revenue into revenue generated from services and revenue generated from product sales. Thus, in conventional systems, the sub-ledger having the services/sales breakout number will lag at least as long as it will take an accountant to enter the data into the sub-ledger. In some cases, this may be days or months.

As such, as a company may choose to transition from this conventional manner of using a general ledger with sub-ledgers into a multi-book accounting system, the point of transition will be problematic because older data already entered may be in a first conventional format while new data entered going forward may be in a new multi-book format. The discrepancies between the formats of old and new data may be problematic in interpreting data from the new multi-book accounting set of books. Thus, the transition from a conventional system to the multi-book system may benefit from organizing the underlying data in a specific manner.

In some embodiments of a multi-book accounting system, apparatuses, and methods for enabling a transition from a conventional accounting system to multi-book accounting functionality while addressing the issue of historical data and transactions, where such functionality provides the ability to maintain multiple sets of accounting records based on a single set of real-time financial transactions. Among other benefits, this allows a business to support different managerial and regulatory compliance needs. In some embodiments, the systems, apparatuses, and methods enable the creation of a new accounting book within an existing multi-book accounting system while addressing the issue of historical data and transactions. Further, various embodiments are directed to systems, apparatuses, and methods for migrating data from one accounting or data processing system to another system.

Other objects and advantages of the present subject matter will be apparent to one of ordinary skill in the art upon review of the detailed description of the specification and the included figures.

FIG. 1 is a diagram illustrating elements or components of an example operating environment in which an embodiment may be implemented. In FIG. 1, an example operating environment 100 includes a variety of clients 102 incorporating and/or incorporated into a variety of computing devices that may communicate with a distributed computing service/platform 108 through one or more networks 114. For example, a client may incorporate and/or be incorporated into a client application (e.g., software) implemented at least in part by one or more of the computing devices. Examples of suitable computing devices include personal computers, server computers 104, desktop computers 106, laptop computers 107, notebook computers, tablet computers or personal digital assistants (PDAs) 110, smart phones 112, cell phones, and consumer electronic devices incorporating one or more computing device components, such as one or more electronic processors, microprocessors, central processing units (CPU), or controllers. Examples of suitable networks 114 include networks utilizing wired and/or wireless communication technologies and networks operating in accordance with any suitable networking and/or communication protocol (e.g., the Internet).

The distributed computing service/platform (which may also be referred to as a multi-tenant business-data-processing platform) 108 may include multiple processing tiers, including a user interface tier 116, an application server tier 120, and a data storage tier 124. The user interface tier 116 may maintain multiple user interfaces 117, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, and the like. Each processing tier shown in FIG. 1 may be implemented with a set of computers and/or computer components including computer servers and processors, and may perform various functions, methods, processes, or operations as determined by the execution of a software application or set of instructions. The data storage tier 124 may include one or more data stores, which may include a service data store 125 and one or more tenant data stores 126.

Each tenant data store 126 may contain tenant-specific data that is used as part of providing a range of tenant-specific business services or functions, including but not limited to ERP, CRM, eCommerce, Human Resources management, payroll, and the like. Data stores may be implemented with any suitable data storage technology, including structured query language (SQL) based relational database management systems (RDBMS).

In accordance with one embodiment, the distributed computing service/platform 208 may be a multi-tenant and service platform 108 and may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an ERP system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 122 that are part of the platform's Application Server Tier 120.

Another business information system that may be provided as part of an integrated data processing and service platform is an integrated CRM system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. In addition to ERP and CRM functions, a business information system/platform (such as element 108 of FIG. 1) may also include one or more of an integrated partner and vendor management system, eCommerce system (e.g., a virtual storefront application or platform), product lifecycle management (PLM) system, Human Resources management system (which may include medical/dental insurance administration, payroll, and the like), or supply chain management (SCM) system. Such functions or business applications are typically implemented by one or more modules of software code/instructions that are maintained on and executed by one or more servers 122 that are part of the platform's Application Server Tier 120.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, and the like. A web server is a most often a combination of hardware and the software that helps deliver content (typically by hosting a website) to client web browsers that access the web server via the Internet.

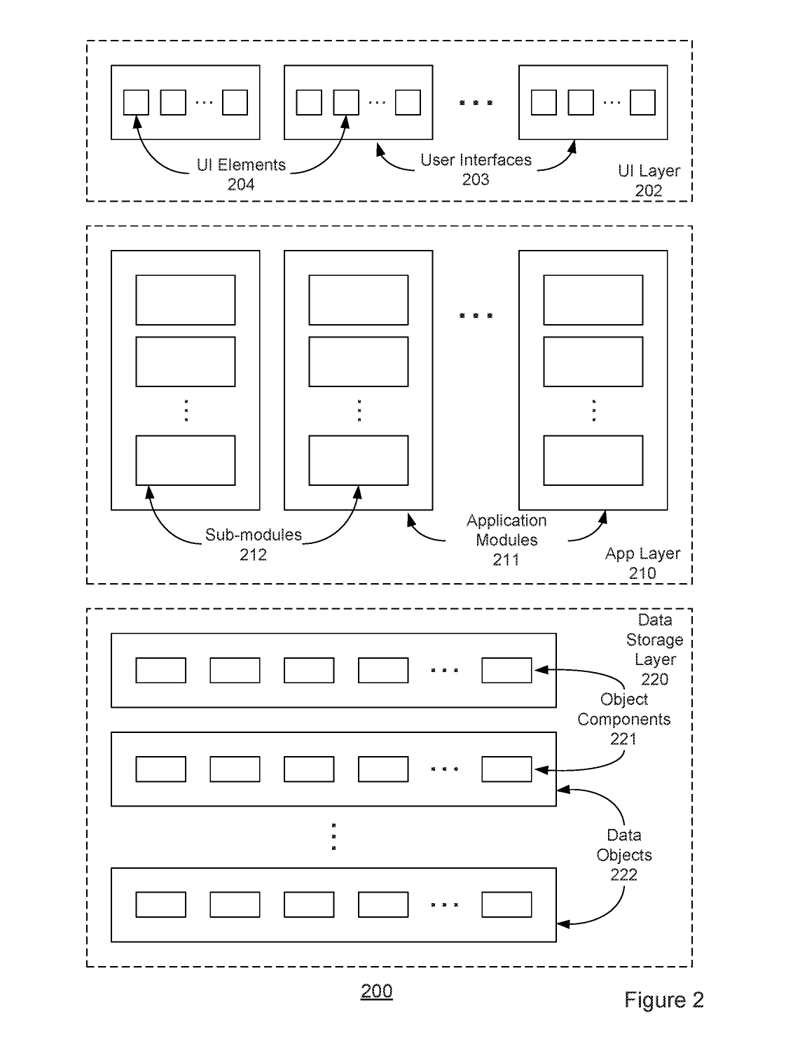

Rather than build and maintain such an integrated business system themselves, a business may utilize systems provided by a third party. Such a third party may implement an integrated business system as described above in the context of a multi-tenant platform, wherein individual instantiations of a single comprehensive integrated business system are provided to a variety of tenants. However, one challenge in such multi-tenant platforms is the ability for each tenant to tailor their instantiation of the integrated business system to their specific business needs. In one embodiment, this limitation may be addressed by abstracting the modifications away from the codebase and instead supporting such increased functionality through custom transactions as part of the application itself. Prior to discussing additional aspects of custom transactions, additional aspects of the various computing systems and platforms are discussed next with respect to FIG. 2.

FIG. 2 is a diagram illustrating additional details of the elements or components of the distributed computing service platform of FIG. 1, in which an embodiment may be implemented. The software architecture depicted in FIG. 2 represents an example of a complex software system to which an embodiment may be applied. In general, an embodiment may be applied to any set of software instructions embodied in one or more non-transitory, computer-readable media that are designed to be executed by a suitably programmed processing element (such as a CPU, microprocessor, processor, controller, computing device, and the like). In a complex system such instructions are typically arranged into “modules” with each such module performing a specific task, process, function, or operation. The entire set of modules may be controlled or coordinated in their operation by an operating system (OS) or other form of organizational platform.

In FIG. 2, various elements or components 200 of the multi-tenant distributed computing service platform of FIG. 1 are shown, in which an embodiment may be implemented. The example architecture includes a user interface layer or tier 202 having one or more user interfaces 203. Examples of such user interfaces include graphical user interfaces and application programming interfaces (APIs). Each user interface may include one or more interface elements 204. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 210 may include one or more application modules 211, each having one or more sub-modules 212. Each application module 211 or sub-module 312 may correspond to a particular function, method, process, or operation that is implemented by the module or sub-module (e.g., a function or process related to providing ERP, CRM, eCommerce or other functionality to a user of the platform). Such function, method, process, or operation may also include those used to implement one or more aspects of the system and methods, such as for:
permitting a user on role-by-role basis to generate one or more accounting books (e.g., which may include generating a user interface to enable user interaction with one or more aspects of the systems and methods);
permitting a user on role-by-role basis to define one or more business rules or other forms of logic that describe and determine the content of an accounting book;
linking the generated accounting books to real-time financial data that is maintained and processed by a business data processing system/platform; and
establishing a process for, and controlling the migration of data and data processing operations for a specified set of data and transactions from a conventional accounting system to a multi-book accounting system, or if already operating a multi-book accounting system, from a first set of books to a second set of books.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 122 of FIG. 2) may include each application module. Alternatively, different application servers may include different sets of application modules. Such sets may be disjoint or overlapping.

The data storage layer 220 may include one or more data objects 222 each having one or more data object components 221, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

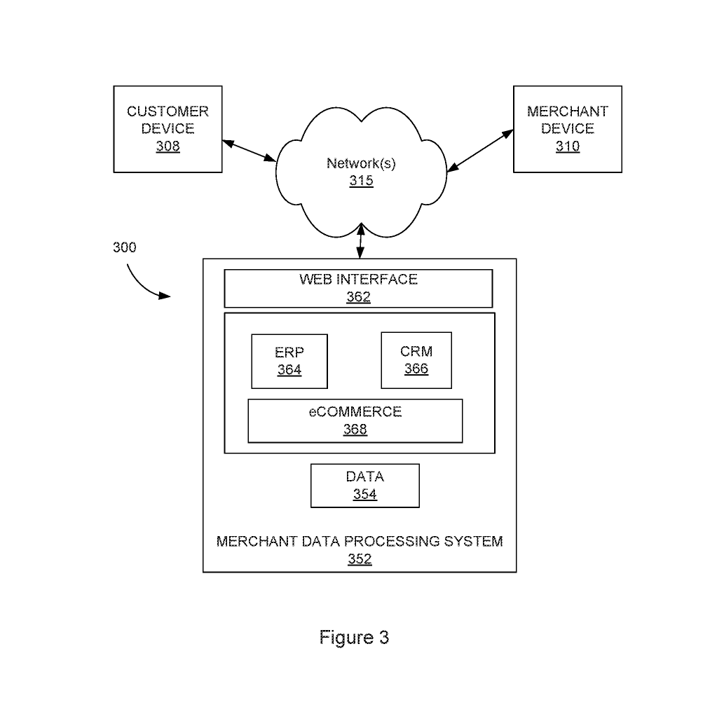

FIG. 3 is a diagram illustrating another perspective of a computing or data processing environment 300 in which an embodiment may be implemented. FIG. 3 illustrates a merchant's data processing system 352, where such a platform or system may be provided to and operated for the merchant by the administrator of a multi-tenant business data processing platform. Thus, the merchant may be a tenant of such a multi-tenant platform, with the elements that are part of system 352 being representative of the elements in the data processing systems available to other tenants. The merchant's data is stored in a data store 354, thereby permitting customers and employees to have access to business data and information via a suitable communication network or networks 315 (e.g., the Internet). Data store 354 may be a secure partition of a larger data store that is shared by other tenants of the overall platform.

A user of the merchant's system 352 may access data, information, and applications (i.e., business related functionality) using a suitable device or apparatus, examples of which include a customer computing device 308 and/or the Merchant's computing device 310. In one embodiment, each such device 308 and 310 may include a client application such as a browser that enables a user of the device to generate requests for information or services that are provided by system 352. System 352 may include a web interface 362 that receives requests from users and enables a user to interact with one or more types of data and applications (such as ERP 364, CRM 366, eCommerce 368, or other applications that provide services and functionality to customers or business employees).

Note that the example computing environments depicted in FIGS. 1-3 are not intended to be limiting examples. Alternatively, or in addition, computing environments in which embodiments may be implemented include any suitable system that permits users to access, process, and utilize data stored in a data storage element (e.g., a database) that can be accessed remotely over a network. Although further examples below may reference the example computing environment depicted in FIGS. 1-3, it will be apparent to one of skill in the art that the examples may be adapted for alternate computing devices, systems, and environments. Attention is now turned to aspects of the multi-book accounting system and transition of operating methods thereto.

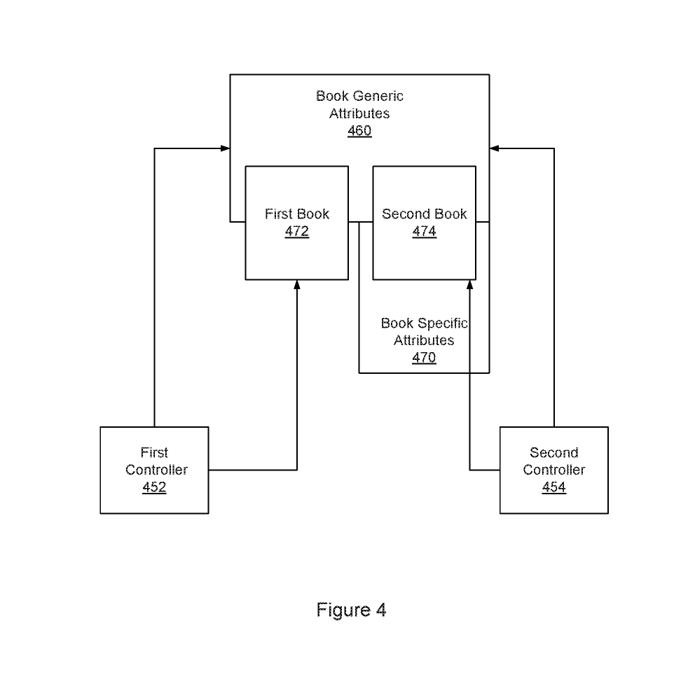

FIG. 4 is a diagram illustrating a data schema 400 that may be utilized in implementing an embodiment of the systems and methods disclosed here that utilize multi-book accounting. As shown in FIG. 4, the data schema 400 permits definition of one or more accounting books that may be decoupled from a General Ledger (GL), in that these books may not be derived directly from a fixed version of the GL, and which may be defined by one or more separate, book specific accounting, business, or operational rules or conditions. In conjunction with the operation of a multi-tenant business data processing platform as described with reference to FIGS. 1-3, this permits one or more accounting books in a set of multi-book accounting books to be based on real-time financial data as filtered or modified by a relevant set of rules or conditions.

Such rules for handling accounting transaction may be based on a number of different principles, aspects, attributes, traits and dependencies. One such rule may simply be currency conversion from one currency to another. Another rules may be a dependency rule that is based on triggering a transaction after the occurrence of an event or when a specific date is reached. Still further rules may be based upon a role of an individual who is entering the data. For example, if a CFO determines that an account receivable is to be written off, then a rule based on the CFO's role in the organization may then trigger the immediate writing off of the account receivable in a new transaction. However, if the user's role is less than CFO, a rule may engaged whereby the written off transaction must be approved by a senior officer. Thus, a new transaction may be accepted into various books in a first manner if the role of the user meets a prerequisite role and accepted into the various books in a second manner if the role of the user does not meet the prerequisite. Other rules may be based upon laws of specific countries and jurisdictions in which the multi-books are kept or intended to be applicable.

Embodiments of a multi-book accounting system may utilize a split transaction line approach that generates multiple copies of real-time book specific accounting results, thus achieving the similar result of a sub-ledger accounting system while enabling multiple copies of accounting results with real-time financial data analytics. In this sense, when a user enters a transaction an underlying data store corresponding to each book that is affected may be modified to reflect the newly entered transaction. Thus, the underlying data is changed in response to the user input according to various sets of defined accounting rules on a per-book basis. The split transaction line approach divides ERP transaction data into book-generic attributes 460 and book-specific attributes 470. Book-generic attributes may be a general ledger accounting of all transactions and necessarily does not include conventional sub-ledger details such as breakdowns in revenue numbers of differing currencies. However, book-specific attributes 470 may, in fact, reflect these additional identifications and logical delineations as well. Thus, the book-specific attributes 470 of a single transaction may be included in one or more specific books in the multi-book accounting system. Using this approach, all transactions entered into a multi-book accounting system will have book-generic attributes 460 that will be included in all books as well as book-specific attributes 470 that will be included in less than all of the books (e.g., only the specific books in which the book-specific attribute 470 applies).

The book-generic attributes 460 are kept intact in a transaction line detail table (not shown). In this sense, this table (an initial table that encompasses only book-generic attributes) may be a general ledger in the conventional sense. That is, in the example embodiment shown in FIG. 4, the first book 472 may also be an equivalent of a conventional general ledger because only book-generic attributes 460 are detailed here.

The data schema 400 of FIG. 4 illustrates an example of a relationship between data for a first book 472 and a second book 474 for use by first and seconds controllers 452 and 454, where a system automatically posts to multiple accounting books according to pre-defined accounting rules once all data is entered for each particular transaction (e.g., both book-generic attributes 460 and book-specific attributes 470. Both the first controller interface 452 and the second controller interface 454 may display book-generic attributes 460. However, the second controller interface 454 displays the book-specific attributes 470 for the second book 474, while the first controller interface 454 does not display the book-specific attributes for second book 474. This allow users to define standard and custom accounting rules, which will be applied to real time business transactions and post to multiple accounting books simultaneously.

To accomplish this, book-specific attributes 470 are appended to a transaction line detail table in an extended transaction line detail table. Run-time transaction processing logic automatically posts transactions to both tables, with the transaction line book detail table containing book-specific accounting results. Thus, a specific charge event or revenue event may be expressed in a first manner in book-generic attributes while the same charge event or revenue event may also be expressed in book-specific attributes as well. Whether an attribute will stay in the transaction line detail table or be relocated to the transaction line book detail table, may be based on one or more of system defined rules, default behavior rules, or user defined accounting rules, and in that sense may be either book-generic (i.e., applicable across all books) or book-specific (i.e., applicable to a subset of the possible books). This approach provides flexibility to general ledger posting logic while reducing a negative impact on system performance. Meanwhile, data analytical tools (such as reports or saved searches) and cloud APIs may be provided to enable access to the transaction line book detail table data without disruption to user experience or interfaces for the transaction line detail table.

In one embodiment as shown in FIG. 4, with respect to the described multi-book accounting system, the first book 472 may be referred to as a primary book and comprises an accounting record prior to implementing a multi-book accounting solution. As such, all transactions contained in the pre-multi-book primary book 472 are detailed in a transaction line detail table (without any extended section of said table). Once multi-book accounting is enabled, the primary book 472 may be then configured and activated for access through the first controller 452 as a separate entity from other accounting books, such as the second book 474. The primary book then becomes a general ledger wherein all book-generic attributes (and often only the book-generic attributes) are stored in the transaction line detail table. The primary book 472 may be the daily operational book where business transactions are recorded and viewed. Further, after establishing the multi-book accounting system, each transaction line detail table is appended with and extended transaction line detail table so as to handle book-specific attributes of the one or more second books 474. Secondary or parallel books, such as second book 474, may have one or more differences from the primary book 472 and are separately accessible through a second controller 454. For example, a secondary book 474 may have different subsidiary base currency, post a particular transaction to different accounts than the primary book 472, and apply different accounting rules.

Book-generic records, such as entity, general ledger or CRM records, are created and shared across all related accounting books. Generally, book-generic attributes on a book-generic transaction display the same result in reports and searches for all accounting books. Many book generic records, such as items, sales orders, sales invoices or vendor bills, may also include book-specific attributes. For example, an item record may be visible in all books, but book specific information for revenue recognition and expense amortization is derived from the item record. Book-specific records or accounting attributes yield different results depending upon the accounting book selected by the user. Book-specific records are typically created for one book only and may include book-specific journal entries (JEs), intercompany journal entries (ICJE), revenue commitment and reclassification JEs, revenue and expense allocation, revenue recognition and expense amortization schedules, or fixed asset depreciation.

Certain implementations of a multi-book accounting system may ensure data integrity through cross-validation rules across multiple accounting books by providing automatic data synchronization for parallel transactions in different accounting books. These cross-validation rules ensure the validity of book specific attributes within the shared book-generic transaction context. For example, a sales invoice carries exactly the same sales price and total sales amount across all applicable accounting books, but users can define cross-book Cost of Acquisition (COA) mapping rules, which are controlled by mapping dimensions such as subsidiary, class, department or location, so that the same sales revenue amount is synchronized across multiple accounting books while posting to different revenue accounts on a per-book basis.

As a further example, a user can create different revenue recognition and expense amortization rules on a per-book basis. If a sales transaction is recorded in the primary book 472, the accounting system may be configured to recognize the associated revenue over a given time period, while immediately recognizing the full amount in the secondary book 474. By doing so, the multi-book accounting system alleviates the tedious manual adjustment and review workload for average accounting users, which is required in a conventional sub-ledger accounting system.

In creating and using new secondary books, a user would do well to ensure data integrity through managed implementation of new secondary books so as to ensure historical transaction processing data integrity at any point during transaction entry. Conventional ERP systems do not allow starting a new accounting book “on the fly.” Rather, the conventional ERP system may require starting a new ERP system instance, so that everything starts from scratch including both primary book and secondary books in this new instance. Once the new instance is established, migration of historical data from the old accounting system to the new one is painstaking and time-consuming. Other conventional system may allow introduction of a secondary book without starting a new system instance, however that requires that the system be temporarily placed “on hold” while processing all historical transactions into the new secondary accounting book. Only after this process is completed, the regular accounting operations resume.

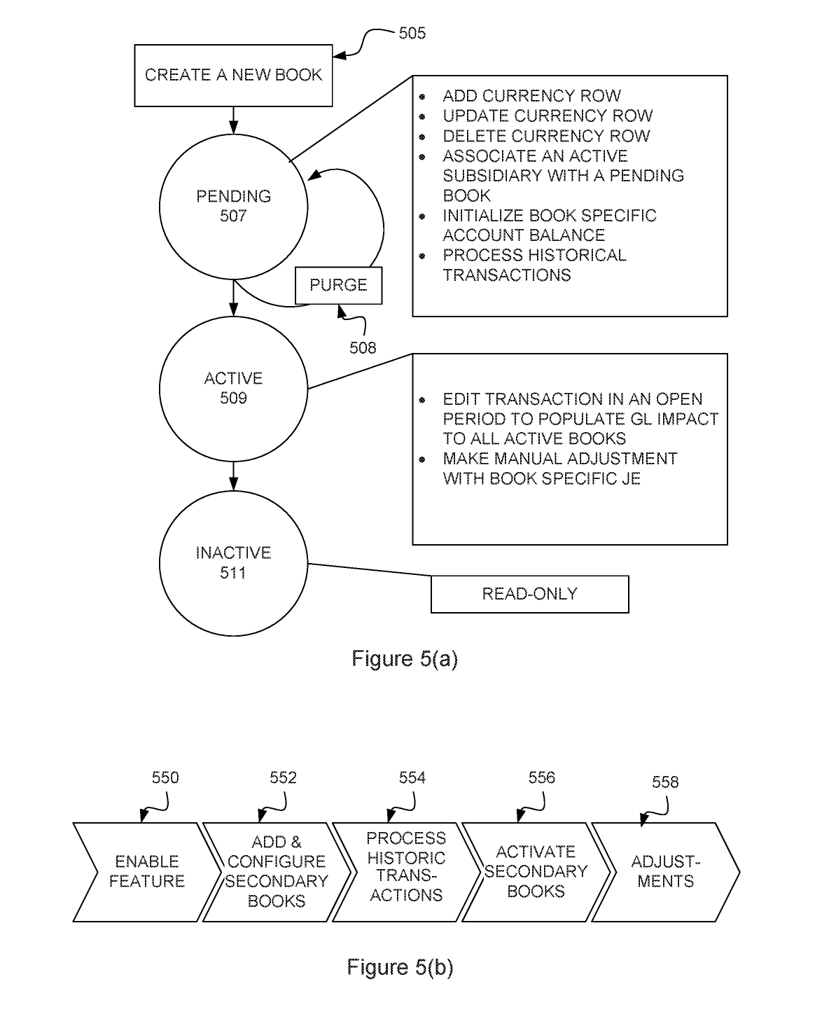

One solution is to introduce a state machine to the accounting books, so that a newly created secondary accounting book can be configured and processed with historical transactions without disrupting daily operations in other accounting books (primary or secondary). FIGS. 5(a) and 5(b) show diagrams of a basic concept of establishing a secondary book via a state machine and historical transaction processing (HTP) logic.

FIG. 5(a) is a state diagram or flow diagram illustrating an exemplary method, process, function, or operation that may be used in an implementation of establishing a new second book after a multi-book accounting system has been established according to an embodiment of the subject matter disclosed herein. In FIG. 5(a), a user may have already established a transition to a multi-book accounting system whereby the one-and-only previous “book” has been transitioned to a primary book or first book subject to a first set of accounting and posting rules. At the outset of the flow diagram of FIG. 5(a), the user may then establish a new second book at state 505. When establishing a new second book within the context of a multi-book accounting system, it is desirable to not interrupt existing operations, or install a new instance of the accounting system just to have a “clean starting point” for new secondary books. A further goal is maintain operation of all other books while the new secondary book is introduced and activated on the fly. If there is a large volume of historical transactions to “translate” to the new secondary book, an enterprise may not necessarily need to migrate ALL of the historical transactions into the new secondary book as this may cause unnecessary data duplication. To avoid this, one may instead select an “effective starting date” of the secondary book, and the system will intelligently migrate only those relevant “open” transactions as of the effective date. These caveats on the implemented solution then provide a clear audit trail of this data migration, so that end users and auditors can audit and/or adjust the data migration during the operations.

With this context in mind, once the user has established a new secondary book complete with at least some posting and/or accounting rules, the secondary book may be transitioned to the pending state 507. “Pending” is the initial state of a new accounting book and engages a procedure called multi-book accounting historical transaction processing (MB-HTP) that includes an automated data migration tool kit that ensures data integrity with respect to historical and future transactions. When a book is pending, a user may accomplish a number of tasks without yet affecting any transaction records (whether they be historical or future). Thus, the secondary book may be configured to a first base period date in which the new secondary book will be effective (e.g., the effective date that defines a “cutoff” point where historical transactions can no longer affect future business operations). Further, while pending, the user may configure a number of different attributes of the secondary book. These book-specific attributes may include adding, deleting, or changing a base currency for subsidiaries in the book, adding an active subsidiary to the book, initializing book-specific account balances, and establishing and processing historical transactions procedures (that may affect transactions that are later than the effective date).

During the pending state 507, records that are prior to the effective date may be purged via quasi-state of purge 508. Fully processed transactions (“closed transactions”) prior to the effective date, cannot affect in future operations, thus these closed transactions may be archived and reflected as a snapshot summary balance as of the effective date. However, open transactions (created but not fully processed) prior to the effective date, will still participate in future operations, but their contribution is limited to the remaining “open balance.” So the data migration process intelligently carries over only the open balances for future operations. By doing so, all “closed transactions” prior to the book effective date (90% of all historical transactions) can be simply summarized through a one-time open balance journal entry (generated automatically by MB-HTP and adjustable by end users) without duplicating all of them into the new secondary book. That is, MB-HTP avoids the unnecessary data duplication of historical transactions that are closed as of the book effective date. Open transaction may have dependency over one or more closed transactions prior to the effective date. In this case, the data migration procedure automatically summarizes dependencies through an “artificial transaction link” that is only “visible” in the new secondary book. In this manner, this dependency is effectively represented in secondary book without reprocessing all dependent closed transactions.

Once the MB-HTP is complete, the overall state machine may place the new secondary book into an active state 509. In the active state, new transactions may be entered into the multi-book system wherein book-generic attributes may be populated across all books and book-specific attributes may be populated in the specific books to which the attributes apply. Further, various transaction may be edited during an open period such that the edits may affect one or more GLs. Further yet, individual may place specific journal entries (JE) in any established and active book via manual adjustment. If any credentialed user wishes to discontinue use of any secondary book, the credentialed user may place the secondary book into an inactive state 511 wherein the data contained in the secondary book GL now becomes read-only and is not affected by any new transaction or any modification to historical transactions. Turning attention back to the MB-HTP, FIG. 5(b) illustrates additional details of this procedure.

FIG. 5(b) is a diagram illustrating a set of steps or stages that represent an exemplary implementation of one embodiment of the MB-HTP method, process, function, or operation in the context of a multi-book accounting system. MB-HTP allows user to define new book (or new feature of an existing book) at any moment, and process historical transactions into the newly enabled feature (namely a new secondary book) through this tool. Once MB-HTP is completed, the new feature or secondary accounting book can be immediately activated and participate in the daily business operations. Through the entire process, existing accounting books, including the primary accounting book and other secondary books that were enabled before, do not need to be put on hold or suspended. Instead, all previously established books in the multi-book environment can continue regular business processes while the new secondary book undergoes configuration, migration and activation.

In one embodiment, MB-HTP may involve a multi-step system process that may begin once a user enables features in a multi-book accounting system to take advantage of creating and using secondary accounting books. This may occur at step 550 in FIG. 5(b). At step 552, a user may create a new secondary book, make necessary book-generic and book-specific accounting book configurations, set an effective date and transition to the new secondary book to the pending state (e.g., collectively add and configure).

At step 554, the method may prompt the handling of historic transactions. This step may include running a trial balance report on the entire chart of accounts (COA), as of the last day right before the effective date period, in the context of primary accounting book. Further, the method step may involve applying a translation currency exchange rate to the primary book trial balance result, derive the desired beginning of pending new secondary book as of the last date prior to book effective date. Further yet, the method step may involve three additional tasks associated with “process open transactions” (e.g., any transaction not deemed to be closed with respect to the effective date of the new secondary book). These three tasks are a) processing open accounts receivable and accounts payable transactions prior to the effective date, b) processing other open balance sheet account balances, such as bank accounts, and c) processing open revenue recognition and expense amortization transactions prior to the effective date.

After all relevant historical transactions are processed in step 554, run trial balance on this pending secondary book and review the account balance result, as of the last day right before the effective date. If the result is different from the initial trial balance on the primary book from step 552, a user has an opportunity to make fine-tune adjustment through book specific journal entries prior to activation. This may include processing selected historical transactions after the effective date but before current system date, with user defined saved search that can be consumed by MB-HTP as an input. Then if the trial balance matches after adjustments, the user may activate the new secondary book at step 556, which will make the secondary book to go live without disrupting regular business in other books. The user may continue to make JE adjustments after activation as well at step 558.

By introducing a pending book state, the system provides end users a live “sandbox” environment to configure, test, migrate and adjust secondary accounting books while the rest of the ERP system is constantly processing daily business activities and transactions. Pending books can continuously intake historical transactions that are created/updated before this book is activated, through the MB-HTP toolkit. The MB-HTP completely eliminates the need to manually process historical transactions into a new secondary book as each is brought “online” as a part of the daily accounting operations.

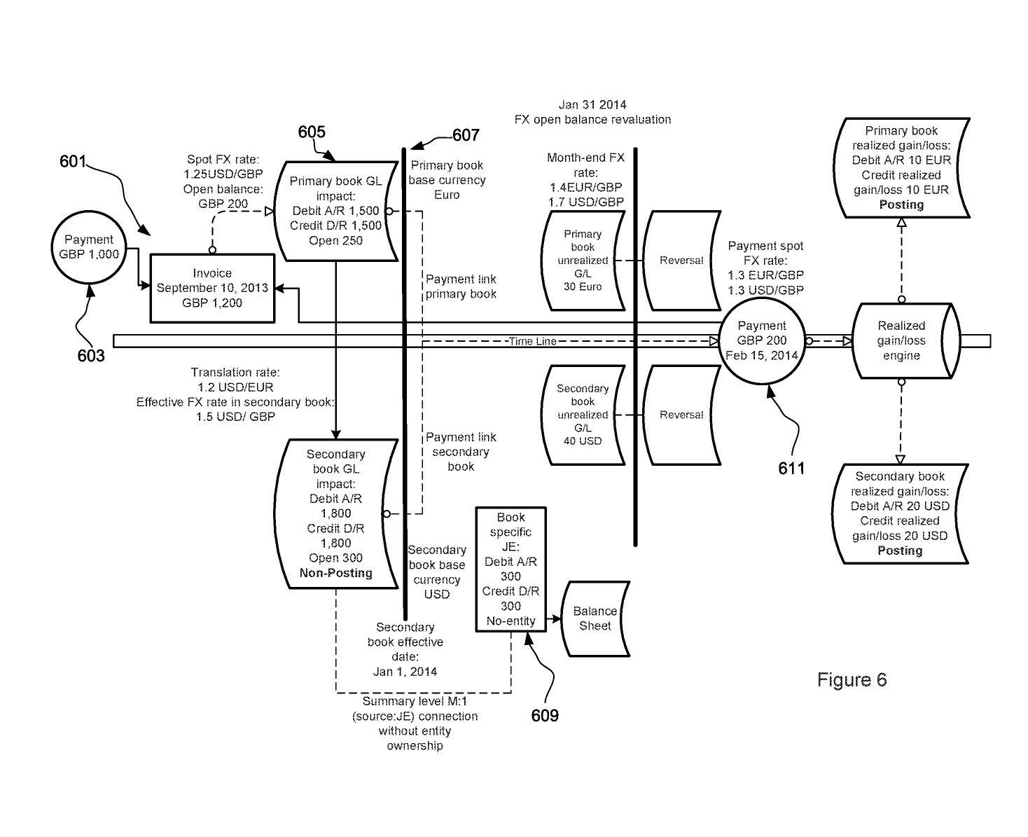

Secondary, the book effective date concept and the selective “Process open transaction only” mechanism effectively archive “closed” historical transactions, without losing the ability to execute business and financial analysis over these data. Meanwhile, if an “open” historical transaction is partially related to one/more “closed” historical transactions prior to the book effective date, MB-HTP can migrate the remaining open balance of these open transactions without pulling an “infinite thread” due to the cross dependency of this open transaction upon other closed transactions. The dependency of this open transaction over other closed transactions is summarized and represented as a secondary book specific “artificial transaction link”. By doing so, an open transaction can still participate in future business operations across all applicable accounting books without worrying its dependency over legacy historical data. An example of such secondary book onboarding is discussed next with respect to FIG. 6.

FIG. 6 is a diagram illustrating a timeline of examples transactions before the implementation of multi-book accounting and after the implementation of multi-book accounting according to an embodiment of the subject matter disclosed herein. In this example, an invoice was created at step 601 on Sep. 13, 2013 with GBP1200 (British pounds) total amount prior to an anticipated new secondary book effective date. Further this invoice, in this example, was partially paid by a check (also prior to the effective date) with GBP1000 at step 603. Now in this example, the primary book may be kept in European Union currency (euros), so at step 605, the spot conversion (currency rate conversion) may be made for both the invoice and the payment.

At this point, the bookkeeper may wish to establish a new secondary book that is kept in US dollars. Thus, an effective date may be set to Jan. 1, 2014 at step 607 which means that the invoice of Sep. 13, 2013 has been partially paid as of the new secondary book effective date. All transaction prior to the effective date are designated as archived and, thus, not transferred over to the new secondary book. Further, any transaction going forward will post to both the primary book (in euros) and the new secondary book (in dollars). However, because the invoice of Sep. 13, 2013 still has an unpaid balance, this transaction will need to be handles via a specific journal entry at step 609 in order to make trial balances match.

Since the partial payment was fully applied and deemed as “closed” transaction in the primary book, only the unpaid balance needs to be brought into the future operation for any new secondary book. This corresponds to the remaining GBP200 balance on the invoice. The paid balance of GBP1000 and corresponding check will be effectively “archived” by MB-HTP, and an “artificial payment” is created as a non-posting GBP1000 book specific document in the new secondary book which reflects dependency of payment over this invoice by two different checks without actually processing the two checks into the new secondary book, since they were made prior to the book effective date. Then, when the future payment of GBP200 is made on Jan. 10, 2015 at step 611, both the primary book and the new secondary book will handle the future transaction correctly albeit with book-specific attributes (such as in euro or in dollars).

The above example is a situation for a company that commonly starts with an opening GL balance but the ERP system will need to interact with business events that precede the starting point such as: open AP/AR transactions, realized and unrealized gain/loss, bank and currency locked assets, inventory valuation, and the like. This situation commonly requires knowledge of historical GL valuation that does not exist due to the effective date of a new secondary book. For example, realized gain/loss is the difference between an amount received in foreign currency for a receivable versus the amount expected in book value. As shown above, this entity receives a payment of GBP200 on Jan. 10, 2015. In order for the system to calculate realized gain/loss for this payment, the system needs to know the GL impact in the new secondary book caused by the invoice which pre-existed the effective date. Having a conventional summarized GL balance in an account is not enough.

In an embodiment using multibook capabilities as discussed herein, realized gain may be computed at the transaction level. Having a secondary book in a different currency allows for the differential of exchange rate between an invoice and a payment to be used to compute a detailed realized gain for each payment application. For payments that are applied across the start date of a new book, one can take advantage of the details in both the Foreign and Accounting book values of the historic invoice in order to compute the gain on the actual payment. Thus, this embodiment generates non-posting detail of the historic transaction so the necessary algorithm can compute the gains regardless of the start date of the new book.

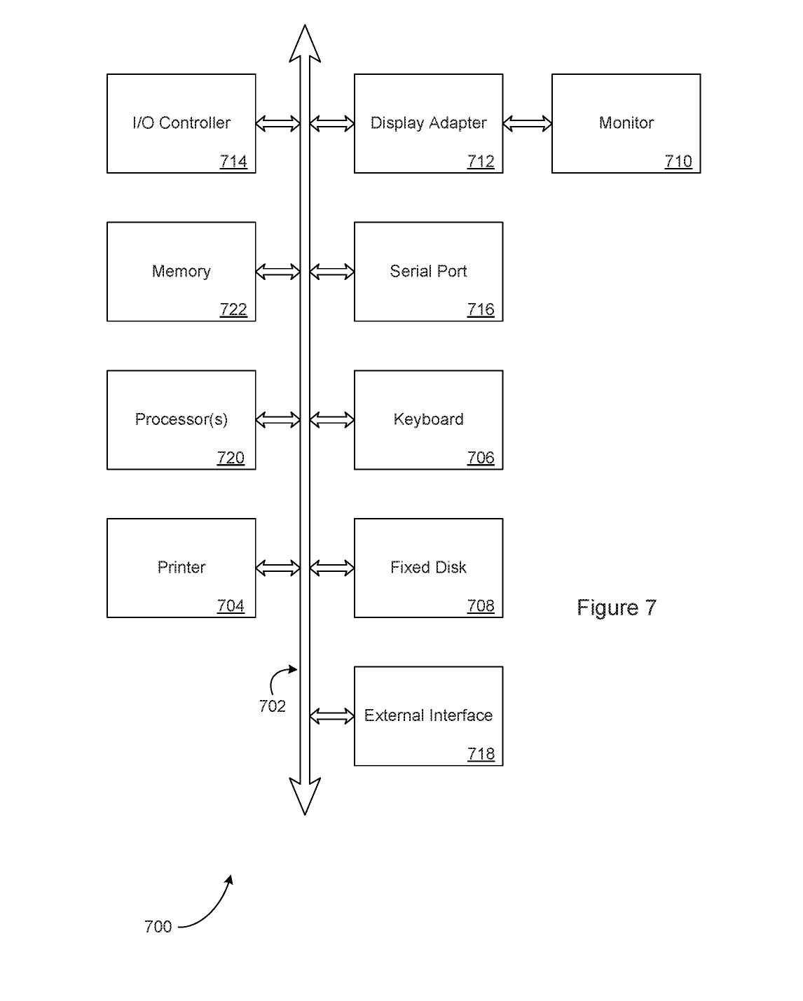

In accordance with one embodiment, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 7 is a diagram illustrating elements or components that may be present in a computer device or system 700 configured to implement a method, process, function, or operation in accordance with an embodiment. The subsystems shown in FIG. 7 are interconnected via a system bus 702. Additional subsystems include a printer 704, a keyboard 706, a fixed disk 708, and a monitor 710, which is coupled to a display adapter 712. Peripherals and input/output (I/O) devices, which couple to an I/O controller 714, can be connected to the computer system by any number of means known in the art, such as a serial port 716. For example, the serial port 716 or an external interface 718 can be utilized to connect the computer device 700 to further devices and/or systems not shown in FIG. 7 including a wide area network such as the Internet, a mouse input device, and/or a scanner. The interconnection via the system bus 702 allows one or more processors 720 to communicate with each subsystem and to control the execution of instructions that may be stored in a system memory 722 and/or the fixed disk 708, as well as the exchange of information between subsystems. The system memory 722 and/or the fixed disk 708 may embody a tangible computer-readable medium.

It should be understood that the present subject matter as described above can be implemented in the form of control logic using computer software in a modular or integrated manner. Based on the disclosure and teachings provided herein, a person of ordinary skill in the art will know and appreciate other ways and/or methods to implement the present embodiments using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A computer-based method for maintaining real-time integrity of accounting data, the method comprising:
maintaining a primary book in an active state for accounting transactions, the primary book including a plurality of transactions having at least a first set of attributes;
creating a new secondary book related to the primary book, the new secondary book created in a pending state that is different from the active state wherein the new secondary book includes at least the first set of attributes and a second set of attributes that are different from the first set of attributes;
populating the new secondary book with transactions from the primary book that correspond to transactions that meet criteria for occurring after an effective date corresponding to the new secondary book, the populating accomplished while the new secondary book is in the pending state; and
transitioning the new secondary book to the active state.

2. The computer-based method of claim 1, wherein the maintaining the primary book comprises:
entering one or more new transactions such that each new transaction changes underlying data about the primary book in a corresponding data store; and
editing one or more existing transactions such that each edit changes underlying data about the primary book in the data store.

3. The computer-based method of claim 1, wherein the new secondary book is created after the primary book has been created, established and maintained.

4. The computer-based method of claim 1, wherein populating the new secondary book further comprises populating with transaction that correspond to a user's role that is creating the new secondary book.

5. The computer-based method of claim 1, further comprising:
creating a new transaction for entry into the primary book, the new transaction having at least one first attribute that corresponds to an attribute in the first set of attributes and the new transaction having at least one second attribute that corresponds to an attribute in the second set of attributes; and
accepting the new transaction into the primary book by updating the records of the primary book and accepting the transaction into the new secondary book.

6. The computer-based method of claim 1, wherein the first attribute of the new transaction and the second attribute of the new transaction cause a balance of primary book and a balance of the new secondary book to change by an equivalent amount.

7. A computer-based method in a multi-tenant computing environment for maintaining real-time integrity of accounting data, the method comprising:
establishing set of accounting books including a primary book for accounting transactions that includes a plurality of transactions, the set of accounting books further including a plurality of secondary books such that each secondary book comprises less than all of the plurality of transactions;
creating a new transaction for entry into the primary book, the new transaction having at least one first attribute that is common to all transactions and the new transaction having at least one second attribute that is common to transactions in at least one secondary book but not common to at least one other secondary book; and
accepting the new transaction into the primary book by updating the primary book and accepting the transaction into each secondary book in which the at least one secondary attribute is common with the new transaction.

8. The computer-based method of claim 7, further comprising storing the at least one attribute that is common to all transactions in a transaction line table.

9. The computer-based method of claim 7, further comprising storing the at least one attribute that is common to transactions in at least one secondary book but not common to at least one other secondary book in an extended transaction line table.

10. The computer-based method of claim 7, wherein the at least one attribute corresponds to a role of a user.

11. The computer-based method of claim 7, wherein the at least one attribute corresponds to a currency.

12. The computer-based method of claim 7, wherein the at least one attribute corresponds to a date.

13. The computer-based method of claim 7, wherein the at least one attribute corresponds to a product or service.

14. The computer-based method of claim 7, wherein the at least one attribute corresponds to a geographic region.

15. The computer-based method of claim 7, further comprising:
determining a role of the user creating the new transaction;
accepting the new transaction in a first manner if the role of the user meets a prerequisite; and
accepting the new transaction in a second manner if the role of the user does not meet the prerequisite.

16. The computer-based method of claim 7, further comprising:
determining a role of the user creating the new transaction;
accepting the new transaction in the primary book if the role of the user meets a prerequisite; and
accepting the new transaction in at least one secondary book if the role of the user does not meet the prerequisite.

17. A multi-tenant computing system for maintain accounting data integrity, the system comprising:
a data store for storing data corresponding to a set of accounting books for a tenant in a multi-tenant computing platform;
a processor coupled to the data store and configured to execute instructions stored in a memory for causing:
maintaining a primary book in an active state for accounting transactions, the primary book including a plurality of transactions having at least a first set of attributes;
creating a new secondary book related to the primary book, the new secondary book created in a pending state that is different from the active state wherein the new secondary book includes at least the first set of attributes and a second set of attributes that are different from the first set of attributes;
populating the new secondary book with transactions from the primary book that correspond to transactions that meet criteria for occurring after an effective date corresponding to the new secondary book, the populating accomplished while the new secondary book is in the pending state; and
transitioning the new secondary book to the active state.

18. The multi-tenant computing system of claim 17, wherein the processor is further configured to execute instructions causing:
entering one or more new transactions such that each new transaction changes underlying data about the primary book in a corresponding data store; and
editing one or more existing transactions such that each edit changes underlying data about the primary book in the data store.

19. The multi-tenant computing system of claim 17, wherein the first attribute of the new transaction and the second attribute of the new transaction cause a balance of primary book and a balance of the new secondary book to change by an equivalent amount.

20. The multi-tenant computing system of claim 17, wherein the processor is further configured to execute instructions causing:
creating a new transaction for entry into the primary book, the new transaction having at least one first attribute that corresponds to an attribute in the first set of attributes and the new transaction having at least one second attribute that corresponds to an attribute in the second set of attributes; and
accepting the new transaction into the primary book by updating the records of the primary book and accepting the transaction into the new secondary book.
